(19) United States
(12) Patent Application Publication
(10) Pub. No.: US 2014/0005973 A1
(43) Pub. Date: Jan. 2, 2014

(54) METHOD OF EXAMINING TEST APPARATUS FOR WIRELESS NETWORK DEVICE

(71) Applicant: ASKEY COMPUTER CORP., NEW TAIPEI CITY (TW)

(72) Inventors: YU-CHEN LU, NEW TAIPEI CITY (TW); YUNG-HUNG LAN, TAIPEI CITY (TW)

(73) Assignee: ASKEY COMPUTER CORP., NEW TAIPEI CITY (TW)

(21) Appl. No.: 13/673,370

(22) Filed: Nov. 9, 2012

(30) Foreign Application Priority Data
Jun. 29, 2012 (TW) 101123455

(51) Int. Cl. G06F 19/00

(52) U.S. Cl. CPC G06F 19/00
USPC 702/122

(57) ABSTRACT

A method of examining a test apparatus for a wireless network device is performed with a computer apparatus, a vector signal analyzer, and a vector signal generator and includes a signal receiving/transmitting step and a result outputting step. A transmitting signal test value and a receiving signal test value of the wireless network device test apparatus are measured by transmitting a reference signal of the vector signal generator and performing a receiving procedure of the wireless network device test apparatus and by transmitting a test signal of the wireless network device test apparatus and performing a receiving procedure of the vector signal analyzer, respectively. After the computer apparatus outputs an error of the wireless network device test apparatus and a comparison table of standard tolerance. Accordingly, the method enables self-testing to be performed and thereby dispenses with high fees charged by examination institutions for examining the test apparatus.

### CROSS-REFERENCE TO RELATED APPLICATION

This non-provisional application claims priority under 35 U.S.C. §119(a) on Patent Application No(s).101123455 filed in Taiwan, R.O.C. on Jun. 29, 2012, the entire contents of which are hereby incorporated by reference.

### FIELD OF TECHNOLOGY

The present invention relates to examination methods, and more particularly, to a method for examining a test apparatus for use with a wireless network device by a computer apparatus, a vector signal analyzer, and a vector signal generator.

### BACKGROUND

A conventional test apparatus for use with a wireless network device features an IQ series, such as IQflex, IQnxn, and IQview, is intended to test and determine whether the communication functionality of a wireless communication product is satisfactory or not. After having been in use for a while, the test apparatus has to be calibrated, so as to ensure that the test apparatus in operation does not go beyond a tolerance set forth in standard specifications.

However, the prior art discloses sending the test apparatus to the manufacturer for undergoing an examination procedure at high examination costs.

### SUMMARY OF THE INVENTION

It is an objective of the present invention to provide a method for performing a do-it-yourself examination procedure with a view to cutting production costs of wireless communication products.

In order to achieve the above and other objectives, the present invention provides a method of examining a test apparatus for a wireless network device, using a computer apparatus, a vector signal analyzer, and a vector signal generator. The method comprises a signal receiving/transmitting step and a result outputting step. The signal receiving/transmitting step is intended for obtaining a transmitting signal test value and a receiving signal test value of the test apparatus. The signal receiving/transmitting step essentially comprises: a signal receiving test step, wherein the computer apparatus controls the vector signal generator to generate and send a reference signal carrying a transmitting signal reference value to the test apparatus, such that the test apparatus generates and sends the receiving signal test value to the computer apparatus, thereby allowing the computer apparatus to produce a signal receiving test result report; and a signal transmitting test step, wherein the computer apparatus controls the test apparatus to generate and send a test signal carrying the transmitting signal test value to the vector signal analyzer, such that the vector signal analyzer generates and sends a receiving signal reference value to the computer apparatus, thereby allowing the computer apparatus to produce a signal transmitting test result report. The result outputting step is intended for sending a comparison table comparing an error data of the test apparatus and a standard tolerance data based on the signal receiving test result report and the signal transmitting test result report.

In an embodiment, the signal receiving test step comprises the sub-steps of: (a1) connecting the computer apparatus, the vector signal generator, the test apparatus, and the computer apparatus in series, in sequence, and by wired connection; (a2) controlling the vector signal generator to generate and send the reference signal carrying the transmitting signal reference value to the test apparatus by the computer apparatus and through wired transmission; (a3) configuring a frequency band of the test apparatus for matching that of the reference signal by the computer apparatus; (a4) generating the receiving signal test value upon receipt of the reference signal and sending the receiving signal test value to the computer apparatus by the test apparatus and through wired transmission; and (a5) recording the receiving signal test value and the transmitting signal reference value of the reference signal and producing the signal receiving test result report by the computer apparatus. In sub-step (a1), a wireless receiving end of the test apparatus is connected to the vector signal generator by the wired connection.

In an embodiment, the signal transmitting test step comprises the sub-steps of: (b1) connecting the computer apparatus, the vector signal analyzer, the test apparatus, and the computer apparatus in series, in sequence, and by wired connection; (b2) controlling the test apparatus to generate and send the test signal carrying the transmitting signal test value to the vector signal analyzer by the computer apparatus and through wired transmission; (b3) configuring a frequency band of the vector signal analyzer for matching that of the test signal by the computer apparatus; (b4) generating the receiving signal reference value upon receipt of the test signal and sending the receiving signal reference value to the computer apparatus by the vector signal analyzer and through wired transmission; and (b5) recording the receiving signal reference value and the transmitting signal test value of the test signal and producing the signal transmitting test result report by the computer apparatus. In sub-step (b1), a wireless transmitting end of the test apparatus is connected to the vector signal analyzer by the wired connection.

In an embodiment, the method further comprises, prior to producing the signal receiving test result report and the signal transmitting test result report, the sub-step of configuring an attenuation parameter of an external cable, so as to compensate for signal attenuation caused by the cable of the signal receiving test result report and the signal transmitting test result report, respectively.

Accordingly, the present invention discloses analyzing and generating signals by a high-precision vector signal analyzer and a high-precision vector signal generator, producing a test result report by means of a reference signal and a test signal which are of a known value and a corresponding output from a test apparatus, and outputting an error data attributed to the test apparatus and shown in the test result report as well as a comparison table comparing an error data of the test apparatus and a standard tolerance data, to thereby enable a user to determine whether an error of the test apparatus goes beyond a standard tolerance and thus requires a maintenance service offered by a manufacturer.

### BRIEF DESCRIPTION OF THE DRAWINGS

Objectives, features, and advantages of the present invention are hereunder illustrated with specific embodiments in conjunction with the accompanying drawings, in which:

FIG. 1 is a schematic view of how a test apparatus for a wireless network device according to an embodiment of the present invention works;

FIG. 2 is a flow chart of an examination method carried out with a test apparatus for a wireless network device according to an embodiment of the present invention; and

FIG. 3 are detailed flow charts of a signal receiving step and a signal transmitting step of FIG. 2, respectively.

### DETAILED DESCRIPTION OF THE PREFERRED EMBODIMENTS

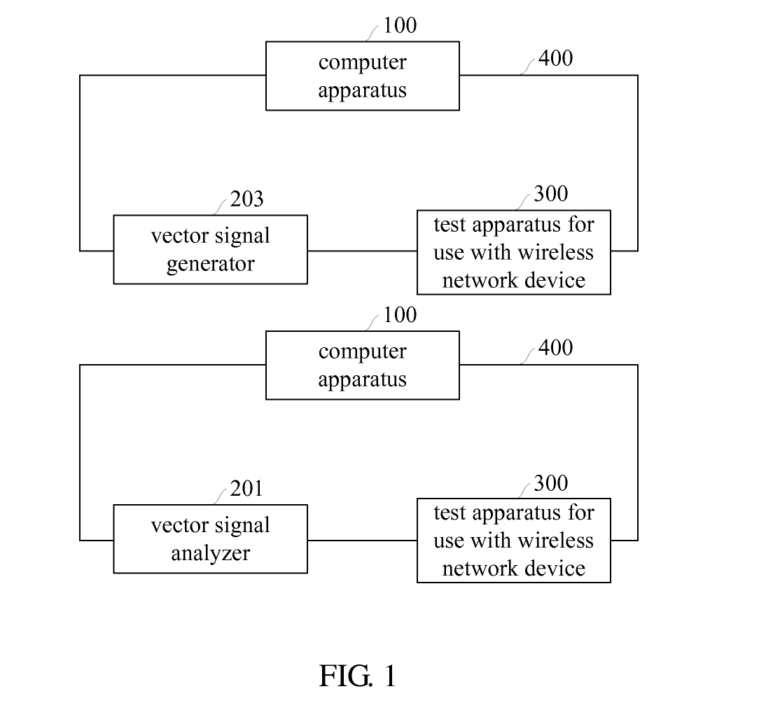

Referring to FIG. 1, there is shown a schematic view of how a test apparatus for a wireless network device according to an embodiment of the present invention works. In an embodiment of the present invention, a test apparatus 300 for use with a wireless network device examination method comprises a computer apparatus 100, a vector signal analyzer 201, and a vector signal generator 203, which are connected together in a circle, that is, in the form of a loop-like testing circuit, in a wired manner, for example, by means of a connection wire 400.

Referring to FIG. 1, the examination method comprises two testing steps which are not necessarily carried out in specific sequence, and thus the devices involved may vary. The connection wire 400 thus provided depends on the specifications of the devices and equipment. For example, possible choices include a GPIB connection wire, a RF cable, and an Ethernet cable, which are disclosed in the prior art and thus are not described in detail hereunder for the sake of brevity.

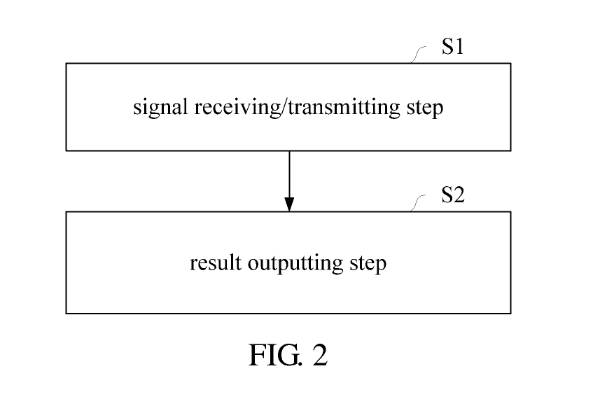

Referring to FIG. 2, there is shown a flow chart of an examination method carried out with a test apparatus for a wireless network device according to an embodiment of the present invention. The method comprises the steps of:

Step (S1): a signal receiving/transmitting step that involves obtaining a transmitting signal test value and a receiving signal test value of the test apparatus 300.

The signal receiving/transmitting step essentially comprises a signal receiving test step and a signal transmitting test step. In the signal receiving test step, the computer apparatus 100 controls the vector signal generator 203 (such as a vector signal generator or VSG for short) to generate and send a reference signal to the test apparatus 300, wherein the reference signal carries a transmitting signal reference value, such that the test apparatus 300 can generate and send the receiving signal test value to the computer apparatus 100, thereby allowing the computer apparatus 100 to produce a signal receiving test result report. In the signal transmitting test step, the computer apparatus 100 controls the test apparatus 300 to generate and send a test signal to the vector signal analyzer 201 (such as a power meter), wherein the test signal carries the transmitting signal test value, such that the vector signal analyzer 201 generates and sends a receiving signal reference value to the computer apparatus 100, thereby allowing the computer apparatus 100 to produce a signal transmitting test result report.

Step (S2): a result outputting step that involves sending a comparison table comparing an error data of the test apparatus 300 and a standard tolerance data based on the signal receiving test result report and the signal transmitting test result report to enable a user to determine whether an error of the test apparatus goes beyond a standard tolerance and thus requires a maintenance service offered by a manufacturer.

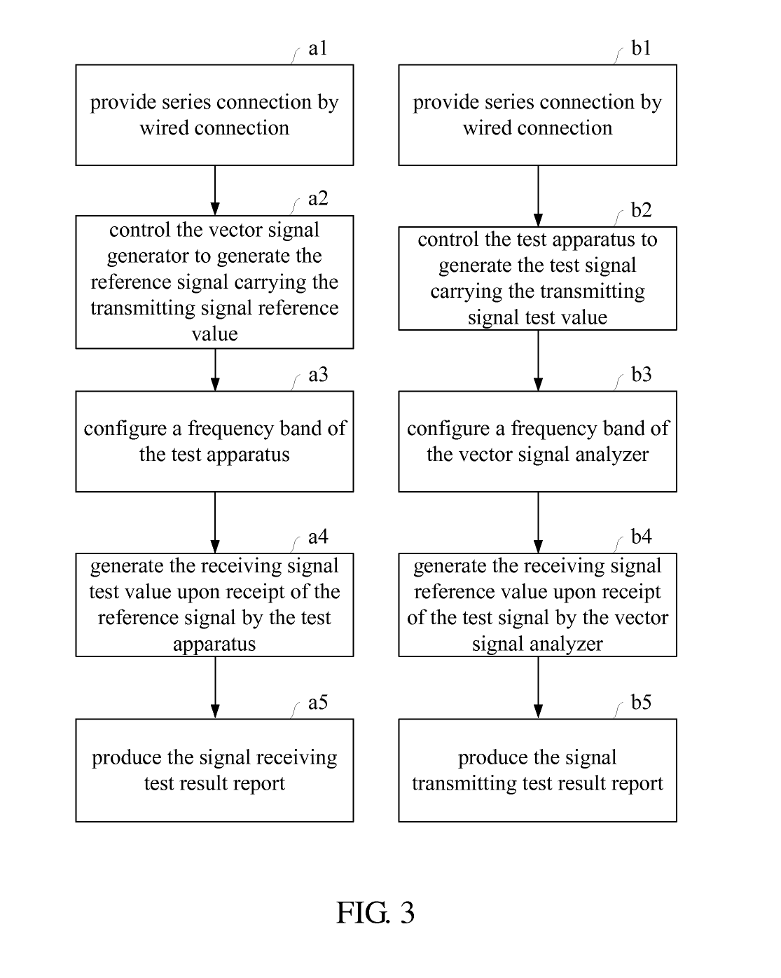

Referring to FIG. 3, there are shown detailed flow charts of a signal receiving step and a signal transmitting step of FIG. 2, respectively.

Referring to FIG. 3, the signal receiving test step comprises the following sub-steps:

Sub-step (a1): the computer apparatus 100, the vector signal generator 203, and the test apparatus 300 are connected in series and in sequence, by wired connection, and in the form of a loop-like signal circuit, as shown in FIG. 1. In the state of wired connection, a wireless receiving end of the test apparatus 300 is connected to the vector signal generator 203 by the wired connection, so as to not only receive data by wired transmission, but also prevent signal attenuation or interference which might otherwise occur during wireless transmission, thereby enhancing the accuracy of the examination. The test apparatus is capable of wireless transmission and wired transmission.

Sub-step (a2): given wired transmission, the computer apparatus 100 controls the vector signal generator 203 to generate and send the reference signal carrying the transmitting signal reference value to the test apparatus 300.

Sub-step (a3): the computer apparatus 100 configures a frequency band of the test apparatus 300 for matching that of the reference signal.

Sub-step (a4): the test apparatus 300 generates the receiving signal test value after receiving the reference signal and sends the receiving signal test value to the computer apparatus 100 by wired transmission.

Sub-step (a5): the computer apparatus 100 records the receiving signal test value and the transmitting signal reference value of the reference signal and produces the signal receiving test result report.

Referring to FIG. 3, the signal transmitting test step comprises the following sub-steps:

Sub-step (b1): the computer apparatus 100, the vector signal analyzer 201, and the test apparatus 300 are connected in series and in sequence, by wired connection, and in the form of a loop-like signal circuit, as shown in FIG. 1. In the state of wired connection, a wireless transmitting end of the test apparatus 300 is connected to the vector signal analyzer 201 by the wired connection, so as to not only transmit data by wired transmission, but also prevent signal attenuation or interference which might otherwise occur during wireless transmission, thereby enhancing the accuracy of the examination.

Sub-step (b2): given wired transmission, the computer apparatus 100 controls the test apparatus 300 to generate and send the test signal carrying the transmitting signal test value to the vector signal analyzer 201.

Sub-step (b3): the computer apparatus 100 configures a frequency band of the vector signal analyzer for matching that of the test signal.

Sub-step (b4): the vector signal analyzer 201 generates the receiving signal reference value after receiving the test signal and sends the receiving signal reference value to the computer apparatus 100 by wired transmission.

Sub-step (b5): the computer apparatus 100 records the receiving signal reference value and the transmitting signal test value of the test signal and produces the signal transmitting test result report.

Prior to producing the signal receiving test result report in sub-step (a5) and producing the signal transmitting test result report in sub-step (b5), the signal receiving test step and the signal transmitting test step further comprises the sub-step (not shown) of configuring an attenuation parameter of an external cable, so as to compensate for the signal attenuation caused by the cable of the signal receiving test result report and the signal transmitting test result report, respectively.

The test apparatus is applicable to different operating frequency bands, such as 2.4 GHz (2412˜2484 MHz) and 5 GHz (4915˜5825 MHz), and each frequency band has different powers. Hence, it is feasible to test each frequency band and each power thoroughly. In an embodiment, upon completion of sub-step (a4), the process flow goes back to sub-step (a2), such that the process flow will not end unless and until all the operating frequencies of the test apparatus have been tested. Alternatively, upon completion of sub-step (b4), the process flow goes back to sub-step (b2), such that the process flow will not end unless and until all the operating frequencies of the test apparatus have been tested. In doing so, it is feasible to produce a thorough test report.

The table below is a text comparison table.

TABLE 1
Examination and Comparison Table

| | | | | Actual |
|---|---|---|---|---|
| Test Frequency | Standard | Actual | Standard Tolerance | Tolerance |
| Band (MHz) | (dBm) | (dBm) | (dBm) | (dBm) |
| 2412 | −40 | −40.12 | ±1 | −0.12 |
| 2417 | −40 | −40.17 | ±1 | −0.17 |
| 2422 | −40 | −40.19 | ±1 | −0.19 |
| 2427 | −40 | −40.25 | ±1 | −0.25 |
| 2432 | −40 | −40.17 | ±1 | −0.17 |

In conclusion, in an embodiment of the present invention, a user determines whether an error of the test apparatus goes beyond a standard tolerance and thus requires a maintenance service offered by a manufacturer at a high maintenance cost, with a view to cutting production costs of wireless communication products.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A method of examining a test apparatus for a wireless network device, using a computer apparatus, a vector signal analyzer, and a vector signal generator, the method comprising:
a signal receiving/transmitting step for obtaining a transmitting signal test value and a receiving signal test value of the test apparatus, the signal receiving/transmitting step essentially comprising:
a signal receiving test step, wherein the computer apparatus controls the vector signal generator to generate and send a reference signal carrying a transmitting signal reference value to the test apparatus, such that the test apparatus generates and sends the receiving signal test value to the computer apparatus, thereby allowing the computer apparatus to produce a signal receiving test result report; and
a signal transmitting test step, wherein the computer apparatus controls the test apparatus to generate and send a test signal carrying the transmitting signal test value to the vector signal analyzer, such that the vector signal analyzer generates and sends a receiving signal reference value to the computer apparatus, thereby allowing the computer apparatus to produce a signal transmitting test result report; and
a result outputting step for sending a comparison table comparing an error data of the test apparatus and a standard tolerance data based on the signal receiving test result report and the signal transmitting test result report.

2. The method of claim 1, wherein the signal receiving test step comprises the sub-steps of:
(a1) connecting the computer apparatus, the vector signal generator, the test apparatus, and the computer apparatus in series, in sequence, and by wired connection;
(a2) controlling the vector signal generator to generate and send the reference signal carrying the transmitting signal reference value to the test apparatus by the computer apparatus and through wired transmission;
(a3) configuring a frequency band of the test apparatus for matching that of the reference signal by the computer apparatus;
(a4) generating the receiving signal test value upon receipt of the reference signal and sending the receiving signal test value to the computer apparatus by the test apparatus and through wired transmission; and
(a5) recording the receiving signal test value and the transmitting signal reference value of the reference signal and producing the signal receiving test result report by the computer apparatus.

3. The method of claim 2, further comprising, prior to producing the signal receiving test result report and the signal transmitting test result report, the sub-step of configuring an attenuation parameter of an external cable, so as to compensate for signal attenuation caused by the cable of the signal receiving test result report and the signal transmitting test result report, respectively.

4. The method of claim 2, wherein, in sub-step (a1), a wireless receiving end of the test apparatus is connected to the vector signal generator by the wired connection.

5. The method of claim 4, further comprising, prior to producing the signal receiving test result report and the signal transmitting test result report, the sub-step of configuring an attenuation parameter of an external cable, so as to compensate for signal attenuation caused by the cable of the signal receiving test result report and the signal transmitting test result report, respectively.

6. The method of claim 1, wherein the signal transmitting test step comprises the sub-steps of:
(b1) connecting the computer apparatus, the vector signal analyzer, the test apparatus, and the computer apparatus in series, in sequence, and by wired connection;
(b2) controlling the test apparatus to generate and send the test signal carrying the transmitting signal test value to the vector signal analyzer by the computer apparatus and through wired transmission;
(b3) configuring a frequency band of the vector signal analyzer for matching that of the test signal by the computer apparatus;
(b4) generating the receiving signal reference value upon receipt of the test signal and sending the receiving signal reference value to the computer apparatus by the vector signal analyzer and through wired transmission; and
(b5) recording the receiving signal reference value and the transmitting signal test value of the test signal and producing the signal transmitting test result report by the computer apparatus.

7. The method of claim 6, further comprising, prior to producing the signal receiving test result report and the signal transmitting test result report, the sub-step of configuring an attenuation parameter of an external cable, so as to compensate for signal attenuation caused by the cable of the signal receiving test result report and the signal transmitting test result report, respectively.

8. The method of claim 6, wherein, in sub-step (b1), a wireless transmitting end of the test apparatus is connected to the vector signal analyzer by the wired connection.

9. The method of claim 8, further comprising, prior to producing the signal receiving test result report and the signal transmitting test result report, the sub-step of configuring an attenuation parameter of an external cable, so as to compensate for signal attenuation caused by the cable of the signal receiving test result report and the signal transmitting test result report, respectively.
